(19) United States
(12) Patent Application Publication
(10) Pub. No.: US 2014/0281005 A1
(43) Pub. Date: Sep. 18, 2014

(54) VIDEO RETARGETING USING SEAM CARVING

(71) Applicant: QUALCOMM INCORPORATED, San Diego, CA (US)

(72) Inventors: PhaniKumar K. Bhamidipati, San Diego, CA (US); Vijayalakshmi R. Raveendran, San Diego, CA (US)

(73) Assignee: QUALCOMM Incorporated, San Diego, CA (US)

(21) Appl. No.: 13/834,666

(22) Filed: Mar. 15, 2013

(51) Int. Cl. H04L 29/06

(52) U.S. Cl. CPC H04L 65/607
USPC 709/231

(57) ABSTRACT

Aspects of the present disclosure provide for efficient streaming of video sequences in such a way that multiple receiving devices can simultaneously display the video sequence at their full resolution. For example, some aspects of the disclosure combine seam carving, for retargeting a video sequence, with multiple description coding, for transmission of two or more streams corresponding to descriptions of the video sequence. At the receiving end, the descriptions can be aggregated and decoded, and optionally, resized to full HD resolution utilizing seam lining.

### TECHNICAL FIELD

Aspects of the present disclosure relate generally to methods for streaming media over a communication network, and more particularly, to methods for streaming resized video sequences over a communication network utilizing a multipath aggregation system.

### BACKGROUND

Wireless communication networks are widely deployed to provide various communication services such as telephony, video, data, messaging, broadcasts, and so on.

In many different scenarios, such as for the transmission of images or streaming video media, it is desired to resize or retarget the images. Video retargeting is the repurposing of video from one resolution to another resolution. For example, an HD video (1280×720) may be converted to a WVGA (800×480) video. Of course, any beginning and ending resolution may be used. However, in a typical use case, a higher resolution is repurposed to a lower resolution, such that movies or video streams may be streamed to a small screen such as a tablet, a mobile device, or a television.

Another method for image resizing, known in the art, is called seam carving. Seam carving may be referred to in the literature as image retargeting, content-aware image resizing, content-aware scaling, liquid resizing, or liquid rescaling. Seam carving can be advantageous over other image resizing methods, as it enables consideration of the image content, not just geometric constraints, thereby providing a content-aware resizing of an image.

As the demand for streaming media continues to increase, research and development continue to advance the communication technologies not only to meet the growing demand for access such streaming media, but to advance and enhance the user experience.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the disclosure provide for the utilization of seam carving to resize a video sequence, as a part of a multipath aggregation system configured to enable streaming of the video sequence in a robust and efficient manner to be displayed at a plurality of receiving devices. By utilizing aspects of the disclosure, bandwidth can be saved at a communication network utilized for the streaming of the video sequence, while at the same time, the video sequence can be displayed at each of the plurality of receiving devices at the maximum resolution possible at each device.

In one aspect, the disclosure provides a method of streaming a video sequence, including the steps of resizing an input video sequence utilizing seam carving, encoding a plurality of descriptions of the resized input video sequence utilizing multiple description coding, and transmitting each of the multiple descriptions to a receiver.

Another aspect of the disclosure provides a method of streaming a video sequence, including the steps of resizing an input video sequence, encoding the resized input video sequence to generate a first description, extracting a region of interest from the input video sequence, generating a second description corresponding to the extracted region of interest, and transmitting the first description and the second description to a receiver.

Another aspect of the disclosure provides a method of streaming a video sequence, including the steps of resizing an input video sequence utilizing seam carving, encoding the seam carved input video sequence to generate a first description, resizing the input video sequence utilizing downsampling, encoding the downsampled video sequence to generate a second description, and transmitting the first description and the second description to a receiver.

Another aspect of the disclosure provides a method of streaming a video sequence, including the steps of receiving a plurality of descriptions corresponding to the video sequence, aggregating the plurality of descriptions to generate an aggregated video sequence, decoding the aggregated video sequence to generate a decoded video sequence, rendering the decoded video sequence at a first display, and transmitting information corresponding to the decoded and aggregated descriptions for rendering at a second display.

Another aspect of the disclosure provides a method of streaming a video sequence, including the steps of receiving a plurality of descriptions corresponding to the video sequence, decoding the plurality of descriptions to generate a plurality of decoded video sequences, aggregating the plurality of decoded video sequences to generate an aggregated video sequence, rendering the aggregated video sequence at a first display, and transmitting information corresponding to the aggregated and decoded descriptions for rendering at a second display.

Another aspect of the disclosure provides an apparatus for streaming a video sequence, including means for resizing an input video sequence utilizing seam carving, means for encoding a plurality of descriptions of the resized input video sequence utilizing multiple description coding, and means for transmitting each of the multiple descriptions to a receiver.

Another aspect of the disclosure provides an apparatus for streaming a video sequence, including means for resizing an input video sequence, means for encoding the resized input video sequence to generate a first description, means for extracting a region of interest from the input video sequence, means for generating a second description corresponding to the extracted region of interest, and means for transmitting the first description and the second description to a receiver.

Another aspect of the disclosure provides an apparatus for streaming a video sequence, including means for resizing an input video sequence utilizing seam carving, means for encoding the seam carved input video sequence to generate a first description, means for resizing the input video sequence utilizing downsampling, means for encoding the downsampled video sequence to generate a second description, and means for transmitting the first description and the second description to a receiver.

Another aspect of the disclosure provides an apparatus for streaming a video sequence, including means for receiving a plurality of descriptions corresponding to the video sequence, means for aggregating the plurality of descriptions to generate an aggregated video sequence, means for decoding the aggregated video sequence to generate a decoded video sequence, means for rendering the decoded video sequence at a first display, and means for transmitting information corresponding to the decoded and aggregated descriptions for rendering at a second display.

Another aspect of the disclosure provides an apparatus for streaming a video sequence, including means for receiving a plurality of descriptions corresponding to the video sequence, means for decoding the plurality of descriptions to generate a plurality of decoded video sequences, means for aggregating the plurality of decoded video sequences to generate an aggregated video sequence, means for rendering the aggregated video sequence at a first display, and means for transmitting information corresponding to the aggregated and decoded descriptions for rendering at a second display.

Another aspect of the disclosure provides an apparatus for streaming a video sequence, including a seam carver configured for resizing an input video sequence utilizing seam carving, an encoder configured for encoding a plurality of descriptions of the resized input video sequence utilizing multiple description coding, and a transmitter configured for transmitting each of the multiple descriptions to a receiver.

Another aspect of the disclosure provides an apparatus for streaming a video sequence, including at least one processor, a memory communicatively coupled to the at least one processor, and a communication interface communicatively coupled to the at least one processor, wherein the at least one processor is configured to resize an input video sequence, to encode the resized input video sequence to generate a first description, to extract a region of interest from the input video sequence, to generate a second description corresponding to the extracted region of interest, and to transmit the first description and the second description to a receiver.

Another aspect of the disclosure provides an apparatus for streaming a video sequence, including a seam carver configured for resizing an input video sequence utilizing seam carving, a first encoder configured for encoding the seam carved input video sequence to generate a first description, a downsampler configured for resizing the input video sequence utilizing downsampling, a second encoder configured for encoding the downsampled video sequence to generate a second description, and a transmitter configured for transmitting the first description and the second description to a receiver.

Another aspect of the disclosure provides an apparatus configured for streaming a video sequence, including at least one processor, a communication interface communicatively coupled to the at least one processor, and a memory communicatively coupled to the at least one processor, wherein the at least one processor is configured to receive a plurality of descriptions corresponding to the video sequence, to aggregate the plurality of descriptions to generate an aggregated video sequence, to decode the aggregated video sequence to generate a decoded video sequence, to render the decoded video sequence at a first display, and to transmit information corresponding to the decoded and aggregated descriptions for rendering at a second display.

Another aspect of the disclosure provides an apparatus configured for streaming a video sequence, including at least one processor, a communication interface communicatively coupled to the at least one processor, and a memory communicatively coupled to the at least one processor, wherein the at least one processor is configured to receive a plurality of descriptions corresponding to the video sequence, to decode the plurality of descriptions to generate a plurality of decoded video sequences, to aggregate the plurality of decoded video sequences to generate an aggregated video sequence, to render the aggregated video sequence at a first display, and to transmit information corresponding to the aggregated and decoded descriptions for rendering at a second display.

Another aspect of the disclosure provides a computer-readable storage medium operable for streaming a video sequence, including instructions for causing a computer to resize an input video sequence utilizing seam carving, instructions for causing a computer to encode a plurality of descriptions of the resized input video sequence utilizing multiple description coding, and instructions for causing a computer to transmit each of the multiple descriptions to a receiver.

Another aspect of the disclosure provides a computer-readable storage medium operable for streaming a video sequence, including instructions for causing a computer to resize an input video sequence, instructions for causing a computer to encode the resized input video sequence to generate a first description, instructions for causing a computer to extract a region of interest from the input video sequence, instructions for causing a computer to generate a second description corresponding to the extracted region of interest, and instructions for causing a computer to transmit the first description and the second description to a receiver.

Another aspect of the disclosure provides a computer-readable storage medium operable for streaming a video sequence, including instructions for causing a computer to resize an input video sequence utilizing seam carving, instructions for causing a computer to encode the seam carved input video sequence to generate a first description, instructions for causing a computer to resize the input video sequence utilizing downsampling, instructions for causing a computer to encode the downsampled video sequence to generate a second description, and instructions for causing a computer to transmit the first description and the second description to a receiver.

Another aspect of the disclosure provides a computer-readable storage medium operable for streaming a video sequence, including instructions for causing a computer to receive a plurality of descriptions corresponding to the video sequence, instructions for causing a computer to aggregate the plurality of descriptions to generate an aggregated video sequence, instructions for causing a computer to decode the aggregated video sequence to generate a decoded video sequence, instructions for causing a computer to render the decoded video sequence at a first display, and instructions for causing a computer to transmit information corresponding to the decoded and aggregated descriptions for rendering at a second display.

Another aspect of the disclosure provides a computer-readable storage medium operable for streaming a video sequence, including instructions for causing a computer to receive a plurality of descriptions corresponding to the video sequence, instructions for causing a computer to decode the plurality of descriptions to generate a plurality of decoded video sequences, instructions for causing a computer to aggregate the plurality of decoded video sequences to generate an aggregated video sequence, instructions for causing a computer to render the aggregated video sequence at a first display, and instructions for causing a computer to transmit information corresponding to the aggregated and decoded descriptions for rendering at a second display.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In a similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a hardware implementation for an apparatus employing a processing system in accordance with an aspect of the disclosure.

FIG. 2 is a drawing illustrating a first access terminal transmitting a resized image or video to a plurality of access terminals through a communications network.

FIG. 3 shows an image of a frame in a video sequence for illustrating the methods of FIG. 1.

FIG. 4 is a simplified block diagram illustrating a video streaming system in accordance with one example.

FIG. 5 is a flow chart illustrating a process for streaming video utilizing seam carving for image retargeting in accordance with one example.

FIG. 6 is a simplified block diagram illustrating a video streaming system in accordance with one example.

FIG. 7 is a flow chart illustrating a process for streaming video utilizing seam carving for image retargeting in accordance with one example.

FIG. 8 is a simplified block diagram illustrating a video streaming system in accordance with one example.

FIG. 9 is a flow chart illustrating a process for streaming video utilizing seam carving for image retargeting in accordance with one example.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

According to one or more aspects of the disclosure, a system is disclosed for retargeting a media stream utilizing seam carving, and streaming media by utilizing multipath aggregation.

FIG. 1 is a conceptual block diagram illustrating an example of a hardware implementation for an apparatus 100 employing a processing system 114 that may be utilized for video retargeting and/or streaming in accordance with one or more aspects of the disclosure. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a communication interface 110. The communication interface 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software 107 stored on the computer-readable medium 106. The software 107, when executed by the processor 104, causes the processing system 114 to perform the various functions described herein (e.g., streaming a video sequence as described at FIGS. 5, 7, and/or 9) for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may reside in the processing system 114, external to the processing system 114, or distributed across multiple entities including the processing system 114. The computer-readable medium 106 may be embodied in a computer software or program product for processing an image (e.g., image 200). By way of example, a computer program product may include a computer-readable medium in packaging materials. Those skilled in the art will recognize how best to implement the described functionality presented throughout this disclosure depending on the particular application and the overall design constraints imposed on the overall system.

In various aspects of the disclosure, the apparatus 100 may be utilized in a system for streaming multimedia content, such as a video stream that includes a sequence of images, over a communication network. In the description that follows, a first apparatus 100 may be utilized for transmitting a video stream, and a second apparatus 100 may be utilized for receiving the video stream.

For example, FIG. 2 is a drawing illustrating a first access terminal 202 (which may be implemented as the apparatus 100) for transmitting a video stream 210. In the illustration, the first access terminal 202 is shown as a laptop computer, but in various examples within the scope of the disclosure, the first access terminal may be embodied by any suitable computing apparatus, including but not limited to a server, a desktop computer, or a mobile device such as a cellular telephone.

FIG. 2 additionally illustrates second and third access terminals 204 and 206, respectively, for receiving the video stream. Here, the access terminals 204 and 206 may be implemented as the apparatus 100. In the illustration, the second access terminal 204 is illustrated as a tablet computer, and the third access terminal 206 is illustrated as a television set; however, in various examples within the scope of the disclosure, the various access terminals may be embodied by any suitable computing apparatus, including but not limited to a server, a desktop computer, a laptop computer, or a mobile device such as a cellular telephone. When embodied as a television set 206, as illustrated, it is implied that the television set includes some suitable form of communication interface/transceiver, for example, a data interface configured for communication with a network such as the Internet for downloading media content.

The network 208, over which the media content may be transmitted, may be any suitable wired or wireless network, including, in some examples, the Internet, a cellular network following a protocol defined by 3GPP, 3GPP2, or IEEE, or other suitable data communication networks. In some examples, the network 208 may be some combination of two or more such networks.

According to various aspects of the disclosure, to reduce the resources needed at the communication network 208, and/or to configure properties of the image stream itself in accordance with the capabilities of the receiving access terminals 204 and/or 206, the first access terminal 202 may retarget the images corresponding to the video stream. Here, video retargeting is the repurposing of video from one resolution to another resolution. For example, an HD video (1280×720) may be converted to a WVGA (800×480) video. Of course, any beginning and ending resolution may be used. However, in a typical use case, a higher resolution is repurposed to a lower resolution, such that high resolution movies or video streams may be streamed to a small screen such as a tablet, a mobile device, or a standard definition television.

Thus, in one or more aspects of the disclosure, the first access terminal 202 may retarget a video stream prior to transmission, utilizing any suitable algorithm or method for retargeting, including but not limited to image scaling, upsampling/downsampling, cropping of border portions of the images, or any combination of two or more such retargeting schemes.

Another method for image retargeting that may be utilized in one or more aspects of the disclosure is called seam carving. Seam carving may be referred to in the literature as content-aware image resizing, content-aware scaling, liquid resizing, or liquid rescaling. Seam carving can be advantageous over other image resizing methods, as it enables consideration of the image content, not just geometric constraints, thereby providing a content-aware resizing of an image.

Referring now to FIG. 3, For example, with seam carving, a seam 202 or 204 is defined as a connected path of pixels that cross an image, for example, from top to bottom or from left to right. Seam carving is an image operator that can change the size of an image by gracefully carving out pixels in different parts of the image. Seam carving uses an energy function defining the importance of pixels in the image. By successively removing seams, the size of an image can be reduced (i.e., retargeted).

For image size reduction, seams are selected utilizing a suitable energy function in order to preserve the image structure. That is, in accordance with the energy function, more of the low energy pixels will be removed than the high energy pixels. This operator, in effect, produces a content aware resizing of images.

There are several energy functions that may be used, from simple methods such as a gradient measure to more complex methods such as a neighborhood intensity function or an entropy measure. However, the present disclosure is not limited to these energy functions. Other suitable energy functions may be used in various aspects of the disclosure.

Details of image retargeting utilizing any of these schemes are provided in other documents, available to those of ordinary skill in the art, and are accordingly not provided herein. For example, co-pending U.S. patent application Ser. No. 13/834,580 (Attorney Docket No. 130293U1) includes one algorithm for seam carving that may be utilized by the access terminal 202 in some aspects of the disclosure.

In a further aspect of the disclosure, in addition to the retargeting of the video stream, the first access terminal 202 may encode the video stream utilizing a suitable encoding algorithm for transmission to the communication network 208. One coding technique that may be utilized in various aspects of the disclosure is multiple description coding (MDC). MDC, sometimes referred to as multipath aggregation, is a coding technique that is known in the art, and may be used for fragmenting content such as a media stream into multiple substreams, referred to as descriptions. Once they are generated, each of the descriptions can be routed to a client device, which may then aggregate the descriptions to recover the original content.

In MDC, the descriptions are different from one another, but related to one another. That is, the encoding of the descriptions is generally such that any individual one of the descriptions can be decoded to recover the entire content, although a degradation in the quality may be realized if one or more of the descriptions fails to reach the client. Thus, even if one of the streams fails to arrive at its destination, the receiver should still be able to recover the entire content, although some or all of the content may be at a relatively low quality.

MDC can be utilized to increase redundancy, e.g., for sending large files, typically utilizing a protocol such as FTP over a single link, or on a plurality of wireless channels from a single device. Utilization of MDC in this fashion reduces the amount of bandwidth required to receive the content, since not all of the streams are necessary to be received to recover the content. Further, MDC provides improved robustness, since even if one of the streams is lost, the receiver may still recover the entire content, although some portions of it may be at a reduced quality.

Still referring to FIG. 2, the second access terminal 204 and/or the third access terminal 206 may be configured to receive the video stream transmitted from the first access terminal 202. Here, as one example of a use case, streaming video content may be received at a device such as the tablet computer 204. Here, the user may additionally wish to view the same content on their television 206. In a conventional use case, the television 206 may have the ability to pull the same content from the first access terminal 202, e.g., by transmitting a request for the content to the first access terminal 202 by way of the communication network 208. In this case, the first access terminal 202 is sending two different copies of the content: one for the tablet computer 204, and one for the television 206. Moreover, it may be the case that the two copies are received over different paths. For example, the television 206 may be coupled to a broadband Internet connection such as a cable modem, while the tablet computer 204 may be coupled to a 4G network.

In the above example, the user may not be effectively utilizing redundancy of the content being received from the communication network 208. Moreover, one of the displays, such as the tablet computer 204, may receive from the communication network 208 a relatively low-quality video stream, such as WVGA resolution, while the other display (i.e., the television 206) may receive from the communication network 208 a relatively high-quality video stream, such as HD resolution. Here, it may be desired for both displays to receive the HD content.

According to various aspects of the present disclosure, apparatus and methods are disclosed providing for the efficient streaming of video content in such a way that a plurality of display devices can be utilized to render a single received the video stream at the same or different resolutions.

As described above, in some examples, seam carving may be utilized in combination with multiple description coding to generate a video stream at the transmitting/source end. Furthermore, in some examples, at the receiving end, the MDC-encoded video stream may be aggregated and decoded at one or both of the receiving access terminals 204 and/or 206. Here, the decoded video stream may be retargeted to a suitable resolution for viewing at the receiving access terminal. Any suitable retargeting scheme may be utilized at the receiving end, including but not limited to upsampling of the images of a video sequence to a higher resolution. In some examples, a retargeting technique referred to as seam lining may be utilized.

Here, seam lining is a complementary procedure to seam carving, wherein, at the receiving end of a video stream, an inverse operation of the seam carving operation may be performed to obtain a different size image sequence from the version received. That is, seam lining corresponds to an inverse operation of seam carving, wherein seams may be introduced between pixels based on the energy level in the input image.

Here, it is not necessary for the same energy function to be used for seam lining at the receiving side, as was used for the seam carving at the sending side. Further, it is possible that the seams identified at the source may or may not be used in a seam lining procedure. In fact, seam lining may be performed on any image or video stream, irrespective of whether seam carving was previously done on the image or video stream.

Basically, seam lining inserts artificial seams into the image. In one example, optimal horizontal or vertical seams may be identified using a suitable energy function, and pixels at the seam may be duplicated in the horizontal or vertical direction by, for example, averaging them with their neighboring pixels (e.g., left and right neighbors for a vertical seam, or top and bottom neighbors for a horizontal seam). Here, it may be appropriate to take care not to select multiple seams at the same location, so as not to stretch out a part of an image.

Herein below, several different exemplary schemes are disclosed for utilizing seam carving in a multipath aggregation (e.g., MDC) system. In the examples described below, for clarity, an input image/video stream has an HD resolution (1280×720), and a retargeted/downsized image/video stream has a WVGA resolution (800×480). However, those skilled in the art will comprehend that these HD and WVGA resolutions are mere examples, and in various examples within the scope of the disclosure, any suitable resolution may correspond to the input image/video stream and the retargeted/downsized image/video stream.

FIG. 4 is a simplified block diagram illustrating a video streaming system in accordance with some aspects of the disclosure. In the illustration, a source side 402 is illustrated including several functional blocks that may be represented by the apparatus 100, and in some examples, by the first access terminal 202, described above with reference to FIG. 2. Further, a sink side 404 is illustrated including several functional blocks that may be represented by one or more instances of the apparatus 100, and in some examples, by the second access terminal 204 and the third access terminal 206, described above with reference to FIG. 2. According to this example, an HD resolution input video sequence 4022 may be resized, and streamed to two devices. The receiving devices may both be at HD resolution, or optionally, one or both receiving devices may be at a decreased resolution, e.g., WVGA.

At the source end 402, the input video sequence 4022, at HD resolution in this example, may be provided by a server configured for transmitting the video stream. For example, a first access terminal 202 may be embodied as a server configured for transmitting the video stream, such as a YouTube or Netflix server, or any other suitable apparatus configure for streaming video. At a seam carver 4024, the video sequence is resized, e.g., to WVGA resolution, utilizing seam carving as described above. The resized video sequence is then sent to an encoder 4026, configured for multiple description coding, which then divides the WVGA video sequence into two different descriptions D1 and D2, using, for example, a conventional H.264 encoding algorithm. Of course, in any particular implementation, any suitable number of descriptions, from one or more, may be generated by the encoder 4026.

In the illustrated example, the two descriptions D1 and D2 are encoded such that each includes two slices. Here, the first description D1 is shown having a first slice with a quantization parameter QP=30, and a second slice at QP=35; and the second description D2 is complementary, having a first slice at QP=35, and a second slice at QP=30. Here, the slices are regions of the resized (e.g., portions of the video sequence) image encoded by the H.264 encoder such that each slice may be independently decoded. The quantization parameters dictate the quality of the video following the encoding, on a scale from 0 (highest quality) to 51 (lowest quality). For every QP change of 6, the bit rate drops by about half. Thus, for each description, one slice is at a relatively higher quality than the other slice. In this way, reception of either description on its own can be decoded at the sink side 404 to generate an image with at least the quality of the lower quality slice; however, by virtue of the complementary division of quality in the two descriptions, if both descriptions are received the entire video stream can be reconstructed at the higher quality, i.e., corresponding to QP=30. Of course, in any particular implementation, any suitable quantization parameters may be utilized in any particular slice. Moreover, each description may include any suitable number of slices.

Of course, differentiation between the various descriptions (e.g., D1 and D2) at the slice level is merely one of many examples that may be utilized within the scope of the present disclosure. For example, in another aspect of the disclosure, the various descriptions may be differentiated at a frame level. As one example, one description may include even-numbered frames of the video sequence, while another description may include odd-numbered frames of the video sequence. In this case, if only a single description is received, the video sequence may be reproduced at full resolution, but at a reduced frame rate (compared to the slice-level differentiation between descriptions, described above, which would result in full frame rate, but reduced image quality if only a single description were received). Of course, even/odd differentiation is only one simple example that may be utilized when two descriptions are transmitted, and any suitable grouping of sets of frames in the two descriptions may be utilized. Moreover, other numbers of descriptions may be utilized, for example, every third frame in a three-description example, or any other suitable grouping of frames wherein the respective descriptions include complementary sets of frames.

Yet another example may differentiate the respective descriptions by including some full frames at a first quality (e.g., at HD resolution), while including other frames at a second quality (e.g., at WVGA resolution). As one example, with two descriptions, the first description may include a sequence of 16 frames at one quality, followed by a sequence of 16 frames at another quality. Further, the second description may include complementary sets of frames, in such a way that when both descriptions are received, the low-quality frames may be discarded, and the entire stream may be reproduced utilizing only the higher quality frames.

Returning to FIG. 4, the source end 402 transmits the multiple descriptions D1 and D2 over a suitable communication interface 210, e.g., to the communication network 208 (see FIG. 2). Here, the respective descriptions may be configured such that they are addressed to different receiving units, as described below. That is, in some aspects of the disclosure, the descriptions D1 and D2 may take the same path or different paths in the communication network 208, and may be addressed to different respective endpoints, such as, in one example, the tablet 204 and the television 206 (see FIG. 2). In various examples, the communication interface 210 may include an Internet interface such as a cable or DSL modem, a T1 connection, a wireless air interface in a cellular communication network, etc.

At the sink end 404, in one exemplary aspect of the disclosure, two devices (i.e., a tablet 4042 and a television 4044) may each receive respective ones of the descriptions D1 and D2 over respective communication interfaces. Here, any suitable communication interface for communicating with the communication network 208 may be utilized, as described above. While several functional blocks are illustrated at the sink end 404, in various examples, one or more of the functional blocks may reside at the tablet 4042 or at the television 4044, or in some examples at a separate node such as a standalone aggregator module, a decoder module, a computer, or any suitable location.

As seen in FIG. 4, the tablet 4042 and the television 4044 are coupled to an aggregator circuit 4046 for aggregating the received descriptions D1 and D2, and for utilizing slice-level merging to merge the streams together to obtain the full WVGA video stream. For example, when both descriptions are received at the aggregator 4046 may combine slice 1 from D1 with slice 2 from D2, to obtain a full video stream at QP=30, which has a higher quality.

In one example, the aggregator circuit 4046 may be a functional component within one or both of the tablet 4042 and/or the television 4044. In an example where the aggregator 4046 is in the tablet 4042, the D2 bitstream may be transmitted from the television 4044 to the tablet 4042 using a local link 214 (see FIG. 2) between the tablet 4042 and the television 4044, such as Wi-Fi, or any other suitable link. Similarly, in an example where the aggregator 4046 is in the television 4044, the D1 bitstream may be transmitted from the tablet 4042 to the television 4044 utilizing the local link 214.

In this example, once the received descriptions D1 and D2 are merged at the aggregator 4046, the merged video stream is sent to a suitable decoder circuit 4047, such as an H.264 decoder for decoding the video stream from the received description(s). Here, the decoder 4047 may exist at the tablet 4042 and/or the television 4044, or in another example, at any other suitable node communicatively coupled to the aggregator 4046.

The aggregated video stream output from the decoder 4047 may then be passed to a resizer circuit 4048 and/or 4050, which can then optionally resize the image back to a full HD resolution video stream utilizing seam lining, as described above. As one example, the television 4044 may display a resized, HD resolution video, retargeted to HD resolution utilizing seam lining, while the tablet 4042 may display the resized the WVGA resolution video without utilizing seam lining or other retargeting of the video stream.

In a further aspect of the disclosure, if only one of the descriptions D1 or D2 is received at the sink end 404, this received description may be decoded by the decoder 4047, with the decoded video stream being provided to both the tablet 4042 and the television 4044.

FIG. 5 is a flow chart illustrating an exemplary process 500 for streaming video utilizing seam carving for image retargeting in accordance with some aspects of the disclosure. Here, the process 500 illustrated in FIG. 5 may correspond to the block diagram illustrated in FIG. 4. Of course, the process 500 may be implemented by any suitable apparatus, including but not limited to the apparatus 100 illustrated in FIG. 1, the access terminal 202, or any other suitable means for implementing the described functions.

For example, at step 502, the apparatus 402 may resize an input video sequence 4022 from a first resolution to a second resolution (e.g., from HD to WVGA) utilizing seam carving, as described above. For example, a seam carver 4024 may utilize a suitable seam carving algorithm for the resizing of the input video sequence 4022 to a desired size. At step 504, the apparatus 402 may encode a plurality of descriptions of the resized input video sequence utilizing multiple description coding (MDC), as described above. Here, each description may be capable of being independently decoded, such that the sink end 404 can generate an output video sequence even if only a single description of the plurality of descriptions is received.

For example, an MDC encoder 4026 may configure the plurality of descriptions such that they have complementary slices, as illustrated in FIG. 4. In this way, each description of the plurality of descriptions may be utilized at the sink end to generate a decoded video sequence at a first quality (e.g., corresponding to the QP=35 when the slices are as illustrated in FIG. 4); and the plurality of descriptions are capable of being aggregated to generate a decoded video sequence at a second quality, higher than the first quality (e.g., corresponding to the QP=30 when the slices are as illustrated in FIG. 4).

In another example, the MDC encoder 4026 may configure the plurality of descriptions such that they have complementary frames. In this way, each description of the plurality of descriptions may be utilized at the sink end to generate a decoded video sequence at a first frame rate (e.g., corresponding to half the frame rate of the input video sequence); and the plurality of descriptions are capable of being aggregated to generate a decoded video sequence at a second frame rate, higher than the first frame rate (e.g., at the full frame rate of the input video sequence).

In still another example, the MDC encoder 4026 may configure the plurality of descriptions to have complementary frames, but in this example, each description may include all of the frames from the input video sequence, but wherein a first subset of the frames have a first quality, and a second subset of the frames have a second quality. By organizing the frames in each description in a complementary fashion, the descriptions may be aggregated to generate a full frame rate, and full-quality output video sequence.

Of course, those of ordinary skill in the art will comprehend that the scope of the present disclosure is not limited to the details of the above-described particular examples, and in other examples, the above-described examples may be combined or otherwise modified as described herein.

At step 506, the apparatus 402 may transmit each of the multiple descriptions to a receiver. Here, each of the descriptions may be transmitted in any suitable fashion, e.g., utilizing one or more transmitters and/or communication interfaces. For transmission, in one example, each of the transmitted descriptions may be addressed to the same, or to different receiving access terminals, e.g., the access terminals 204 and/or 206 illustrated in FIG. 2. Further, each of the transmitted descriptions may follow the same or different paths or channels through a suitable communication medium such as the communication network 208.

FIG. 5 further illustrates an exemplary process 550 for streaming video in accordance with further aspects of the disclosure. Here, the process 550 illustrated in FIG. 5 may correspond to the block diagram illustrated in FIG. 4. Of course, the process 550 may be implemented by any suitable apparatus, including but not limited to the apparatus 100 illustrated in FIG. 1, the access terminals 204 and/or 206, or any other suitable means for implementing the described functions.

For example, at step 552, the apparatus 404 may receive a plurality of descriptions corresponding to a video sequence. Here, in one example, one access terminal 204 may receive a first description utilizing a first communication interface adapted for communication with the communication network 208, while the access terminal 204 may receive a second description utilizing a second communication interface 214 adapted for communication with another access terminal 206. In this example, the access terminal 206 may have received the second description from the communication network 208 utilizing its own communication interface.

At step 554, the apparatus 404 may aggregate the plurality of descriptions, in order to generate an aggregated video sequence. That is, in this example, due to the nature of the encoding done at the source end 402 as described above, aggregation of the received descriptions may precede the decoding of the video sequence. In various examples, in accordance with the nature of the encoding performed by the MDC encoder 4026, the aggregator 4046 may utilize a suitable aggregation algorithm, such as selecting higher quality slices from each description, interleaving frames from each description, or a combination of the above.

At step 556, the apparatus 404 may decode the aggregated video sequence, to generate a decoded video sequence. For example, a decoder 4047 may utilize a suitable decoding algorithm to decode the video sequence corresponding to the aggregation of the received descriptions.

At step 558, the apparatus 404 may render the decoded video sequence at a first display. For example, the apparatus 404 may utilize local circuitry to render and display the video sequence on its own display circuit. In some examples, the apparatus 404 may further resize the decoded video sequence prior to rendering for local display, e.g., utilizing seam lining, as described above. At step 560, in some examples, the apparatus 404 may transmit information corresponding to the decoded and aggregated descriptions for rendering at a second display. For example, the apparatus 204 may utilize the communication interface 214 to transmit the information to a disparate access terminal 206, such that the access terminal 206 may render the video stream on its own local display.

FIG. 6 is a simplified block diagram illustrating a video streaming system in accordance with further aspects of the disclosure. In the illustration, a source side 602 is illustrated including several functional blocks that may be represented by the apparatus 100, and in some examples, by the first access terminal 202, described above with reference to FIG. 2. Further, a sink side 604 is illustrated including several functional blocks that may be represented by one or more instances of the apparatus 100, and in some examples, by the second access terminal 204 and the third access terminal 206, described above with reference to FIG. 2. According to this example, an HD resolution input video sequence 6022 may be resized, and streamed to two devices. The receiving devices may both be at HD resolution, or optionally, one or both receiving devices may be at a decreased resolution, e.g., WVGA.

At the source end 602, an input video sequence 6022, at HD resolution in this example, may be provided by a server configured for transmitting the video stream. For example, a first access terminal 202 may be embodied as a server configured for transmitting the video stream, such as a YouTube or Netflix server, or any other suitable apparatus configure for streaming video. At a seam carver 6024, the video sequence is resized, e.g., to WVGA resolution, utilizing seam carving as described above. Here, the seam carver 6024 may further be configured to extract certain metadata, which may be useful for determining one or more regions of interest (ROI). The extracted metadata may be sent to ROI determination circuitry 6030, for use in the determination of the ROI. Generation of the ROI is described in further detail below. Here, The resized video sequence, and in some examples, along with the extracted metadata utilized for generating the ROI, is then sent to an encoder 6026 for suitably encoding the resized WVGA video sequence (e.g., an H.264 or other suitable encoder), and to a transmitter 6028 for transmitting a first description D1, including the WVGA-resolution video stream (and in some examples, along with the metadata extracted by the seam carver 6024).

As indicated above, a second description D2 may be generated corresponding to an identified region of interest. That is, by virtue of certain aspects of the seam carving operation, the identification of a region of interest may be facilitated. For example, when the energy function (based upon which seams are identified for removal) defines the energy of various portions of the image in accordance with factors such as the gradient of color and/or intensity across the image, or a discrete cosine transform, it may be possible to distinguish more important parts of the image from less important parts of the image. For example, portions of the image with dense changes in color or intensity might correspond to a region of interest, while portions of the image with few changes in color or intensity might correspond to a background or other relatively unimportant portion of the image. In another example, the ROI may correspond to a portion of an image at the center, which is spatially contiguous. Thus, when the seam carver 6024 generates metadata corresponding to the seam extraction operation and sends this metadata to the ROI extraction circuitry 6030, the ROI extraction circuitry 6030 can better determine regions where important portions of the image may exist. In this example, as seen at the line connecting the seam carver 6024 with the ROI extraction circuit 6030, metadata extracted from the image during the seam carving operation is utilized by the ROI extraction function to improve the ROI extraction. The method or algorithm for extracting the ROI from the input sequence is known in the art, and is not described in detail in this document.

The ROI (or the image sequence corresponding to the generated ROI) is then up-sampled or down-sampled (as needed to result in WVGA resolution, such that the descriptions D1 and D2 are consistent in this example) and encoded for transmission as a second description, D2.

At the sink end 604, in this example, unlike the example illustrated in FIG. 4, a first stage may decode the received descriptions, and following the decoding of the received descriptions, the decoded streams are then merged.

That is, a first device (e.g., a tablet 6042, which may correspond to the tablet 204) receives the first description D1, and sends the received information to a decoder 6044. In an aspect of the disclosure, if the second description D2 is not received, the content corresponding to the first description D1 may be sent directly to a local upsampling block 6046 to be upsampled and displayed on one or both screens (e.g., the local display at the tablet 6042, and in some examples, also at the display at the television 6048). Of course, upsampling is merely one example of the resizing that may be utilized in a particular implementation, and in various examples within the scope of the disclosure, any suitable resizing method, module, or algorithm may be utilized to resize the decoded video stream to a suitable size for display.

Similarly, a second device (e.g., a television 6048, which may correspond to the television 206) receives the second description D2, and sends the received information to a decoder 6050. If the first description is not received, the content corresponding to the second description D2 is up-sampled and displayed on one or both screens. In an aspect of the disclosure, if the first description D1 is not received, the content corresponding to the second description D2 may be sent directly to a local upsampling block 6052 to be upsampled and displayed on one or both screens (e.g., the local display at the television 6048, and in some examples, also at the display at the tablet 6042).

In an example where both descriptions D1 and D2 are received at the receiving devices 6042 and 6048, in this example, after each received description is decoded at the respective decoders 6044 and 6050, the decoded video streams may be provided to an aggregator circuit 6054. Here, the aggregator circuit 6054 is configured to merge the two descriptions D1 and D2 to generate a merged video sequence. In this example, the merged video sequence may combine the region of interest in the second description D2 with the video sequence resized utilizing seam carving in the first description D1. The merged video sequence is then sent to a seam lining circuit 6056, which utilizes seam lining as described above to resize the video stream to HD resolution, after which the HD video stream is sent to the displays at each of the devices 6042 and 6048.

As in the example described above in relation to FIG. 4, in this example, at the sink end 604 the aggregator 6054 may be integrated into either one of the tablet 6042 or the 6048. In such an example, one of the devices may transmit its decoded description to the other device, e.g., utilizing a suitable communication interface 214, such as one configured to utilize a home Wi-Fi network. Here, once the aggregator 6054 merges the descriptions, and in some examples, after the merged video stream is resized, the merged video stream is then sent back to the first device, utilizing the communication interface 214. In another example, each of the tablet 6042 and the television 6048 may include an aggregator 6054. In this example, the respective receiving devices may exchange their received and decoded video streams. Here, the respective video streams may be merged and optionally resized utilizing seam lining for local rendering, without requiring a return to the other receiving device utilizing the communication interface 214.

FIG. 7 is a flow chart illustrating an exemplary process 700 for streaming video utilizing seam carving for image retargeting in accordance with some aspects of the disclosure. Here, the process 700 illustrated in FIG. 7 may correspond to the block diagram illustrated in FIG. 6. Of course, the process 700 may be implemented by any suitable apparatus, including but not limited to the apparatus 100 illustrated in FIG. 1, the access terminal 602, or any other suitable means for implementing the described functions.

For example, at step 702, the apparatus 602 may resize an input video sequence. Here, in one example, the seam carver 6024 may be utilized to resize the input video sequence 6022 from HD resolution to WVGA resolution utilizing seam carving, as described above. Thus, at step 704, the apparatus 602 may encode the resized input video sequence to generate a first description D1. For example, an encoder 6026, such as an H.264 encoder, may be utilized to generate an encoded video stream in accordance with the resized video sequence.

In a further aspect of the disclosure, at step 706, the apparatus 602 may generate certain metadata corresponding the input video sequence 6022, which may be utilized for generating a region of interest (ROI). For example, the seam carver 6024 may be configured to generate metadata during the seam carving operation, for example, identifying various features or characteristics of an image extracted from the energy function and/or the seam carving operation itself, which may be useful in determining important regions or other regions of interest in each frame. Of course, in other various examples within the scope of the disclosure, the generation of the metadata useful for extracting the ROI need not be generated during a seam carving operation, and may be generated either during some other resizing operation, or in another example, in an independent operation separate from resizing of the video sequence.

At step 708, the apparatus 602 may extract the ROI from the input video sequence in accordance with the metadata. For example, ROI extractor 6030 may receive the metadata from the seam carver 6024 and generate the ROI in accordance with the received metadata. Then, at step 710, the apparatus 602 may encode a video stream corresponding to the ROI to generate a second description D2. In some examples, the apparatus 602 may further resize the video stream corresponding to the ROI, e.g., utilizing seam carving, downsampling, or any suitable resizing method or algorithm.

At step 712, the apparatus 602 may transmit each of the multiple descriptions to a receiver. Here, each of the descriptions may be transmitted in any suitable fashion, e.g., utilizing one or more transmitters and/or communication interfaces. For transmission, in one example, each of the transmitted descriptions may be addressed to the same, or to different receiving access terminals, e.g., the access terminals 204 and/or 206 illustrated in FIG. 2. Further, each of the transmitted descriptions may follow the same or different paths or channels through a suitable communication medium such as the communication network 208.

FIG. 7 further illustrates an exemplary process 750 for streaming video in accordance with further aspects of the disclosure. Here, the process 750 illustrated in FIG. 7 may correspond to the block diagram illustrated in FIG. 6. Of course, the process 750 may be implemented by any suitable apparatus, including but not limited to the apparatus 100 illustrated in FIG. 1, the access terminals 204 and/or 206, or any other suitable means for implementing the described functions.

For example, at step 752, the apparatus 604 may receive a plurality of descriptions corresponding to a video sequence. Here, in one example, one access terminal 204 may receive a first description utilizing a first communication interface adapted for communication with the communication network 208, while the access terminal 204 may receive a second description utilizing a second communication interface 214 adapted for communication with another access terminal 206. In this example, the access terminal 206 may have received the second description from the communication network 208 utilizing its own communication interface.

At step 754, the apparatus 604 may decode the plurality of descriptions, in order to generate a plurality of decoded video sequences. That is, in this example, due to the nature of the encoding done at the source end 602 as described above, decoding of the received descriptions may precede the aggregation of the video sequences. Here, a decoder 6044 and/or 6050 may utilize a suitable decoding algorithm to decode the video sequence corresponding to the received descriptions, which generally corresponds to the algorithm utilized at the encoder at the source apparatus 602.

At step 756, the aggregator 6054 may aggregate the plurality of decoded video sequences, in order to generate an aggregated video sequence. For example, when one description corresponds to a retargeted video sequence that is resized utilizing seam carving, and another description corresponds to an ROI, portions of each frame corresponding to the ROI in the seam-carved description may be replaced with a higher-quality ROI from the other description. Of course, this is merely one example, and aggregation at the aggregator 6054 may include any suitable aggregation of multiple descriptions of a video sequence to generate the aggregated video sequence.

At step 758, in some aspects of the disclosure, the apparatus 604 may resize the aggregated video sequence utilizing a suitable retargeting method or algorithm, e.g., seam lining as described above. For example, a seam liner 6056 may upsize a WVGA-resolution video sequence to HD resolution utilizing seam lining, so that the original resolution of the input sequence 6022 from the source side may be regenerated.

At step 760, the apparatus 604 may render the aggregated video sequence to be displayed at a local display device. Further, at step 762, the apparatus 604 may transmit information corresponding to the aggregated and decoded descriptions for rendering at a second display. For example, referring to FIG. 2, a communication interface 214 may be utilized between the access terminals 204 and 206 for transmission of information corresponding to the aggregated video sequence.

FIG. 8 is a simplified block diagram illustrating a video streaming system in accordance with further aspects of the disclosure. In the illustration, a source side 802 is illustrated including several functional blocks that may be represented by the apparatus 100, and in some examples, by the first access terminal 202, described above with reference to FIG. 2. Further, a sink side 804 is illustrated including several functional blocks that may be represented by one or more instances of the apparatus 100, and in some examples, by the second access terminal 204 and the third access terminal 206, described above with reference to FIG. 2. According to this example, an HD resolution input video sequence 8022 may be resized, and streamed to two devices. The receiving devices may both be at HD resolution, or optionally, one or both receiving devices may be at a decreased resolution, e.g., WVGA.

At the source end 802, an input video sequence 8022, at HD resolution in this example, may be provided by a server configured for transmitting the video stream, such as a YouTube or Netflix server, or any other suitable apparatus configure for streaming video. At a seam carver 6024, the video sequence is resized, e.g., to WVGA resolution, utilizing seam carving as described above. Here, the resized video sequence is then sent to an encoder 8026 for suitably encoding the resized WVGA video sequence (e.g., an H.264 or other suitable encoder), and to a transmitter 8028 for transmitting a first description D1, including the WVGA-resolution video stream.

Further, a second description D2 may be generated by sending the input video sequence 8022 to a downsampler 8030, which may resize the video sequence to a lower resolution, e.g., WVGA. That is, in this example, the second description may be a resized version of the input video sequence, utilizing any suitable resizing method or algorithm to resize the input video sequence to a lower resolution such as WVGA. After resizing, the resized video sequence may be sent to an encoder 8032, such as an H.264 or other suitable encoder, and thereby sent to a transmitter 8034 for transmission as the second description D2.

In this example, the sink end 804 may be substantially the same as the sink end 604 described above and illustrated in FIG. 6. For example, the sink end 804 may include a receiver at a tablet 8042, and a receiver at a television 8048. Further each of the tablet 8042 and the television 8048 may include a decoder 8044 and 8050, respectively. Moreover, one or both of the tablet 8042 and/or the television 8048 may include an aggregator 8054 and a seam liner 8056 for merging descriptions of a video stream and resizing the merged video stream. That is, as described above in relation to FIG. 6, a first stage may decode the received descriptions, and following the decoding of the received descriptions, the decoded streams may then be merged. Here, the merging achieved by the aggregator 8054 may function to obtain a video stream having the best qualities from each description D1 and D2. For example, if the seam carving operation completely removes some portions of an image, information corresponding to those portions of the image may be taken from the downsampled version of the image from the other description.

FIG. 9 is a flow chart illustrating an exemplary process 900 for streaming video utilizing seam carving for image retargeting in accordance with some aspects of the disclosure. Here, the process 900 illustrated in FIG. 9 may correspond to the block diagram illustrated in FIG. 6. Of course, the process 900 may be implemented by any suitable apparatus, including but not limited to the apparatus 100 illustrated in FIG. 1, the access terminal 802, or any other suitable means for implementing the described functions.

For example, at step 902, the apparatus 802 may resize an input video sequence utilizing seam carving. Here, in one example, the seam carver 8024 may be utilized to resize the input video sequence 8022 from HD resolution to WVGA resolution utilizing seam carving, as described above. Thus, at step 904, the apparatus 802 may encode the resized input video sequence to generate a first description D1. For example, an encoder 8026, such as an H.264 encoder, may be utilized to generate an encoded video stream in accordance with the resized video sequence.

At step 906, the apparatus 802 may resize the input video sequence utilizing downsampling. Here, in one example, a downsampler 8030 may utilize any suitable method or algorithm for retargeting the input sequence 8022 from a first quality to a second quality, e.g., from HD resolution to WVGA resolution. Thus, at step 908, the apparatus 802 may encode the downsampled video sequence to generate a second description D2. For example, an encoder 8032 may utilize any suitable encoding method or algorithm known to those of ordinary skill in the art.

At step 910, the apparatus 802 may transmit the first and second descriptions to a receiving device. Here, each of the descriptions D1 and D2 may be transmitted in any suitable fashion, e.g., utilizing one or more transmitters and/or communication interfaces. For transmission, in one example, each of the transmitted descriptions may be addressed to the same, or to different receiving access terminals, e.g., the access terminals 204 and/or 206 illustrated in FIG. 2. Further, each of the transmitted descriptions may follow the same or different paths or channels through a suitable communication medium such as the communication network 208.

FIG. 9 further illustrates an exemplary process 950 for streaming video in accordance with further aspects of the disclosure. Here, the process 950 illustrated in FIG. 9 may correspond to the block diagram illustrated in FIG. 8. Of course, the process 950 may be implemented by any suitable apparatus, including but not limited to the apparatus 100 illustrated in FIG. 1, the access terminals 204 and/or 206, or any other suitable means for implementing the described functions.

For example, at step 952, the apparatus 804 may receive a plurality of descriptions corresponding to a video sequence. Here, in one example, one access terminal 204 may receive a first description utilizing a first communication interface adapted for communication with the communication network 208, while the access terminal 204 may receive a second description utilizing a second communication interface 214 adapted for communication with another access terminal 206. In this example, the access terminal 206 may have received the second description from the communication network 208 utilizing its own communication interface.

At step 954, the apparatus 804 may decode the plurality of descriptions, in order to generate a plurality of decoded video sequences. That is, in this example, due to the nature of the encoding done at the source end 802 as described above, decoding of the received descriptions may precede the aggregation of the video sequences. Here, a decoder 8044 and/or 8050 may utilize a suitable decoding algorithm to decode the video sequence corresponding to the received descriptions, which generally corresponds to the algorithm utilized at the encoder at the source apparatus 802.

At step 956, the aggregator 8054 may aggregate the plurality of decoded video sequences, in order to generate an aggregated video sequence. For example, when one description corresponds to a retargeted video sequence that is resized utilizing seam carving, and another description corresponds to a retargeted video sequence that is resized utilizing downsampling, the best portions of each of the two descriptions may be selected and combined to generate the aggregated video sequence. Of course, this is merely one example, and aggregation at the aggregator 8054 may include any suitable aggregation of multiple descriptions of a video sequence to generate the aggregated video sequence.

At step 958, in some aspects of the disclosure, the apparatus 804 may resize the aggregated video sequence utilizing a suitable retargeting method or algorithm, e.g., seam lining as described above. For example, a seam liner 8056 may upsize a WVGA-resolution video sequence to HD resolution utilizing seam lining, so that the original resolution of the input sequence 8022 from the source side may be regenerated.

At step 960, the apparatus 804 may render the aggregated video sequence to be displayed at a local display device. Further, at step 962, the apparatus 804 may transmit information corresponding to the aggregated and decoded descriptions for rendering at a second display. For example, referring to FIG. 2, a communication interface 214 may be utilized between the access terminals 204 and 206 for transmission of information corresponding to the aggregated video sequence.

It is to be understood that the specific order or hierarchy of steps in the methods disclosed herein is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of streaming a video sequence, comprising:
resizing an input video sequence utilizing seam carving;
encoding a plurality of descriptions of the resized input video sequence utilizing multiple description coding; and
transmitting each of the multiple descriptions to a receiver.

2. The method of claim 1, wherein the encoding a plurality of descriptions comprises:
configuring the plurality of descriptions to have complementary slices, such that each description of the plurality of descriptions is capable of being decoded independent of any other description of the plurality of descriptions, to generate a decoded video sequence at a first quality, and wherein the plurality of descriptions are capable of being aggregated to generate a decoded video sequence at a second quality, higher than the first quality.

3. The method of claim 2, wherein the encoding a plurality of descriptions further comprises:
generating a first description of the plurality of descriptions, comprising a first slice corresponding to a first portion of the video sequence, having a first quantization parameter, and a second slice corresponding to a second portion of the video sequence, having a second quantization parameter; and
generating a second description of the plurality of descriptions, comprising a first slice corresponding to the first portion of the video sequence, having the second quantization parameter, and a second slice corresponding to the second portion of the video sequence, having the first quantization parameter.

4. The method of claim 1, wherein the encoding a plurality of descriptions comprises:
configuring the plurality of descriptions to have complementary frames, such that each description of the plurality of descriptions is capable of being decoded independent of any other description of the plurality of descriptions, to generate a decoded video sequence at a first frame rate, and wherein the plurality of descriptions are capable of being aggregated to generate a decoded video sequence at a second frame rate, higher than the first frame rate.

5. The method of claim 4, wherein the encoding a plurality of descriptions further comprises:
generating a first description of the plurality of descriptions, comprising a first set of frames of the video sequence; and
generating a second description of the plurality of descriptions, comprising a second set of frames of the video sequence, comprising different frames from the first set.

6. The method of claim 4, wherein the first set of frames comprises a first subset of frames having a first quality and a second subset of frames having a second quality lower than the first quality, and
wherein the second set of frames comprises a first subset of frames having the second quality and a second subset of frames having the first quality.

7. A method of streaming a video sequence, comprising:
resizing an input video sequence;
encoding the resized input video sequence to generate a first description;
extracting a region of interest from the input video sequence;
generating a second description corresponding to the extracted region of interest; and
transmitting the first description and the second description to a receiver.

8. The method of claim 7, wherein the generating a second description comprises:
resizing and encoding the region of interest.

9. The method of claim 7, further comprising:
generating metadata corresponding to the input video sequence,
wherein the first description further comprises the metadata.

10. The method of claim 9, wherein the resizing the input video sequence comprises utilizing seam carving, and
wherein the seam carving is utilized to generate the metadata.

11. The method of claim 10, wherein the extracting a region of interest from the input video sequence comprises utilizing the metadata generated during the seam carving to determine the region of interest.

12. A method of streaming a video sequence, comprising:
resizing an input video sequence utilizing seam carving;
encoding the seam carved input video sequence to generate a first description;
resizing the input video sequence utilizing downsampling;
encoding the downsampled video sequence to generate a second description; and
transmitting the first description and the second description to a receiver.

13. A method of streaming a video sequence, comprising:
receiving a plurality of descriptions corresponding to the video sequence;
aggregating the plurality of descriptions to generate an aggregated video sequence;
decoding the aggregated video sequence to generate a decoded video sequence;
rendering the decoded video sequence at a first display; and
transmitting information corresponding to the decoded and aggregated descriptions for rendering at a second display.

14. The method of claim 13, further comprising:
resizing the decoded video sequence utilizing seam lining.

15. A method of streaming a video sequence, comprising:
receiving a plurality of descriptions corresponding to the video sequence;
decoding the plurality of descriptions to generate a plurality of decoded video sequences;
aggregating the plurality of decoded video sequences to generate an aggregated video sequence;
rendering the aggregated video sequence at a first display; and
transmitting information corresponding to the aggregated and decoded descriptions for rendering at a second display.

16. The method of claim 15, further comprising:
resizing the aggregated video sequence utilizing seam lining.

17. An apparatus for streaming a video sequence, comprising:
means for resizing an input video sequence utilizing seam carving;
means for encoding a plurality of descriptions of the resized input video sequence utilizing multiple description coding; and
means for transmitting each of the multiple descriptions to a receiver.

18. The apparatus of claim 17, wherein the means for encoding a plurality of descriptions is further configured to encode the plurality of descriptions to have complementary slices, such that each description of the plurality of descriptions is capable of being decoded independent of any other description of the plurality of descriptions, to generate a decoded video sequence at a first quality, and wherein the plurality of descriptions are capable of being aggregated to generate a decoded video sequence at a second quality, higher than the first quality.

19. The apparatus of claim 18, wherein the means for encoding a plurality of descriptions further comprises:
means for generating a first description of the plurality of descriptions, comprising a first slice corresponding to a first portion of the video sequence, having a first quantization parameter, and a second slice corresponding to a second portion of the video sequence, having a second quantization parameter; and
means for generating a second description of the plurality of descriptions, comprising a first slice corresponding to the first portion of the video sequence, having the second quantization parameter, and a second slice corresponding to the second portion of the video sequence, having the first quantization parameter.

20. The apparatus of claim 17, wherein the means for encoding a plurality of descriptions is further configured to encode the plurality of descriptions to have complementary frames, such that each description of the plurality of descriptions is capable of being decoded independent of any other description of the plurality of descriptions, to generate a decoded video sequence at a first frame rate, and wherein the plurality of descriptions are capable of being aggregated to generate a decoded video sequence at a second frame rate, higher than the first frame rate.

21. The apparatus of claim 20, wherein the means for encoding a plurality of descriptions further comprises:
means for generating a first description of the plurality of descriptions, comprising a first set of frames of the video sequence; and
means for generating a second description of the plurality of descriptions, comprising a second set of frames of the video sequence, comprising different frames from the first set.

22. The apparatus of claim 20, wherein the first set of frames comprises a first subset of frames having a first quality and a second subset of frames having a second quality lower than the first quality, and
wherein the second set of frames comprises a first subset of frames having the second quality and a second subset of frames having the first quality.

23. An apparatus for streaming a video sequence, comprising:
means for resizing an input video sequence;
means for encoding the resized input video sequence to generate a first description;
means for extracting a region of interest from the input video sequence;
means for generating a second description corresponding to the extracted region of interest; and
means for transmitting the first description and the second description to a receiver.

24. The apparatus of claim 23, wherein the means for generating a second description is configured for resizing and encoding the region of interest.

25. The apparatus of claim 23, further comprising:
means for generating metadata corresponding to the input video sequence,
wherein the first description further comprises the metadata.

26. The apparatus of claim 25, wherein the means for resizing the input video sequence is configured to utilize seam carving, and
wherein the seam carving is utilized to generate the metadata.

27. The apparatus of claim 26, wherein the means for extracting a region of interest from the input video sequence is configured to utilize the metadata generated during the seam carving to determine the region of interest.

28. An apparatus for streaming a video sequence, comprising:
means for resizing an input video sequence utilizing seam carving;
means for encoding the seam carved input video sequence to generate a first description;
means for resizing the input video sequence utilizing downsampling;
means for encoding the downsampled video sequence to generate a second description; and
means for transmitting the first description and the second description to a receiver.

29. An apparatus for streaming a video sequence, comprising:
means for receiving a plurality of descriptions corresponding to the video sequence;
means for aggregating the plurality of descriptions to generate an aggregated video sequence;
means for decoding the aggregated video sequence to generate a decoded video sequence;
means for rendering the decoded video sequence at a first display; and
means for transmitting information corresponding to the decoded and aggregated descriptions for rendering at a second display.

30. The apparatus of claim 29, further comprising:
means for resizing the decoded video sequence utilizing seam lining.

31. An apparatus for streaming a video sequence, comprising:
means for receiving a plurality of descriptions corresponding to the video sequence;
means for decoding the plurality of descriptions to generate a plurality of decoded video sequences;
means for aggregating the plurality of decoded video sequences to generate an aggregated video sequence;
means for rendering the aggregated video sequence at a first display; and
means for transmitting information corresponding to the aggregated and decoded descriptions for rendering at a second display.

32. The apparatus of claim 31, further comprising:
means for resizing the aggregated video sequence utilizing seam lining.

33. An apparatus for streaming a video sequence, comprising:
a seam carver configured for resizing an input video sequence utilizing seam carving;
an encoder configured for encoding a plurality of descriptions of the resized input video sequence utilizing multiple description coding; and
a transmitter configured for transmitting each of the multiple descriptions to a receiver.

34. The apparatus of claim 33, wherein the encoder, being configured for encoding a plurality of descriptions, is further configured for configuring the plurality of descriptions to have complementary slices, such that each description of the plurality of descriptions is capable of being decoded independent of any other description of the plurality of descriptions, to generate a decoded video sequence at a first quality, and wherein the plurality of descriptions are capable of being aggregated to generate a decoded video sequence at a second quality, higher than the first quality.

35. The apparatus of claim 34, wherein the encoder, being configured for encoding a plurality of descriptions, is further configured for:
generating a first description of the plurality of descriptions, comprising a first slice corresponding to a first portion of the video sequence, having a first quantization parameter, and a second slice corresponding to a second portion of the video sequence, having a second quantization parameter; and
generating a second description of the plurality of descriptions, comprising a first slice corresponding to the first portion of the video sequence, having the second quantization parameter, and a second slice corresponding to the second portion of the video sequence, having the first quantization parameter.

36. The apparatus of claim 33, wherein the encoder, being configured for encoding a plurality of descriptions, is further configured for configuring the plurality of descriptions to have complementary frames, such that each description of the plurality of descriptions is capable of being decoded independent of any other description of the plurality of descriptions, to generate a decoded video sequence at a first frame rate, and wherein the plurality of descriptions are capable of being aggregated to generate a decoded video sequence at a second frame rate, higher than the first frame rate.

37. The apparatus of claim 36, wherein the encoder, being configured for encoding a plurality of descriptions, is further configured for:
generating a first description of the plurality of descriptions, comprising a first set of frames of the video sequence; and
generating a second description of the plurality of descriptions, comprising a second set of frames of the video sequence, comprising different frames from the first set.

38. The apparatus of claim 36, wherein the first set of frames comprises a first subset of frames having a first quality and a second subset of frames having a second quality lower than the first quality, and
wherein the second set of frames comprises a first subset of frames having the second quality and a second subset of frames having the first quality.

39. An apparatus for streaming a video sequence, comprising:
at least one processor;
a memory communicatively coupled to the at least one processor; and
a communication interface communicatively coupled to the at least one processor,
wherein the at least one processor is configured to:
resize an input video sequence;
encode the resized input video sequence to generate a first description;
extract a region of interest from the input video sequence;
generate a second description corresponding to the extracted region of interest; and
transmit the first description and the second description to a receiver.

40. The apparatus of claim 39, wherein the at least one processor, being configured to generate a second description, is further configured to resize and encode the region of interest.

41. The apparatus of claim 39, wherein the at least one processor is further configured to:
generate metadata corresponding to the input video sequence,
wherein the first description further comprises the metadata.

42. The apparatus of claim 41, wherein the at least one processor, being configured to resize the input video sequence, is further configured to utilize seam carving, wherein the seam carving is utilized to generate the metadata.

43. The apparatus of claim 42, wherein the at least one processor, being configured to extract a region of interest from the input video sequence, is further configured to utilize the metadata generated during the seam carving to determine the region of interest.

44. An apparatus for streaming a video sequence, comprising:
a seam carver configured for resizing an input video sequence utilizing seam carving;
a first encoder configured for encoding the seam carved input video sequence to generate a first description;
a downsampler configured for resizing the input video sequence utilizing downsampling;
a second encoder configured for encoding the downsampled video sequence to generate a second description; and
a transmitter configured for transmitting the first description and the second description to a receiver.

45. An apparatus configured for streaming a video sequence, comprising:
at least one processor;
a communication interface communicatively coupled to the at least one processor; and
a memory communicatively coupled to the at least one processor,
wherein the at least one processor is configured to:
receive a plurality of descriptions corresponding to the video sequence;
aggregate the plurality of descriptions to generate an aggregated video sequence;
decode the aggregated video sequence to generate a decoded video sequence;
render the decoded video sequence at a first display; and
transmit information corresponding to the decoded and aggregated descriptions for rendering at a second display.

46. The apparatus of claim 45, wherein the at least one processor is further configured to resize the decoded video sequence utilizing seam lining.

47. An apparatus configured for streaming a video sequence, comprising:
at least one processor;
a communication interface communicatively coupled to the at least one processor; and
a memory communicatively coupled to the at least one processor,
wherein the at least one processor is configured to:
receive a plurality of descriptions corresponding to the video sequence;
decode the plurality of descriptions to generate a plurality of decoded video sequences;
aggregate the plurality of decoded video sequences to generate an aggregated video sequence;
render the aggregated video sequence at a first display; and
transmit information corresponding to the aggregated and decoded descriptions for rendering at a second display.

48. The apparatus of claim 47, wherein the at least one processor is further configured to resize the aggregated video sequence utilizing seam lining.

49. A computer-readable storage medium operable for streaming a video sequence, comprising:
instructions for causing a computer to resize an input video sequence utilizing seam carving;
instructions for causing a computer to encode a plurality of descriptions of the resized input video sequence utilizing multiple description coding; and
instructions for causing a computer to transmit each of the multiple descriptions to a receiver.

50. The computer-readable storage medium of claim 49, wherein the instructions for causing a computer to encode a plurality of descriptions are further configured to cause a computer to encode the plurality of descriptions to have complementary slices, such that each description of the plurality of descriptions is capable of being decoded independent of any other description of the plurality of descriptions, to generate a decoded video sequence at a first quality, and wherein the plurality of descriptions are capable of being aggregated to generate a decoded video sequence at a second quality, higher than the first quality.

51. The computer-readable storage medium of claim 50, wherein the instructions for causing a computer to encode a plurality of descriptions further comprise:
instructions for causing a computer to generate a first description of the plurality of descriptions, comprising a first slice corresponding to a first portion of the video sequence, having a first quantization parameter, and a second slice corresponding to a second portion of the video sequence, having a second quantization parameter; and
instructions for causing a computer to generate a second description of the plurality of descriptions, comprising a first slice corresponding to the first portion of the video sequence, having the second quantization parameter, and a second slice corresponding to the second portion of the video sequence, having the first quantization parameter.

52. The computer-readable storage medium of claim 49, wherein the means for encoding a plurality of descriptions is further configured to encode the plurality of descriptions to have complementary frames, such that each description of the plurality of descriptions is capable of being decoded independent of any other description of the plurality of descriptions, to generate a decoded video sequence at a first frame rate, and wherein the plurality of descriptions are capable of being aggregated to generate a decoded video sequence at a second frame rate, higher than the first frame rate.

53. The computer-readable storage medium of claim 52, wherein the instructions for causing a computer to encode a plurality of descriptions further comprise:
instructions for causing a computer to generate a first description of the plurality of descriptions, comprising a first set of frames of the video sequence; and
instructions for causing a computer to generate a second description of the plurality of descriptions, comprising a second set of frames of the video sequence, comprising different frames from the first set.

54. The computer-readable storage medium of claim 52, wherein the first set of frames comprises a first subset of frames having a first quality and a second subset of frames having a second quality lower than the first quality, and
wherein the second set of frames comprises a first subset of frames having the second quality and a second subset of frames having the first quality.

55. A computer-readable storage medium operable for streaming a video sequence, comprising:
instructions for causing a computer to resize an input video sequence;
instructions for causing a computer to encode the resized input video sequence to generate a first description;
instructions for causing a computer to extract a region of interest from the input video sequence;
instructions for causing a computer to generate a second description corresponding to the extracted region of interest; and
instructions for causing a computer to transmit the first description and the second description to a receiver.

56. The computer-readable storage medium of claim 55, wherein the instructions for causing a computer to generate a second description are further configured for resizing and encoding the region of interest.

57. The computer-readable storage medium of claim 55, further comprising:
instructions for causing a computer to generate metadata corresponding to the input video sequence,
wherein the first description further comprises the metadata.

58. The computer-readable storage medium of claim 57, wherein the instructions for causing a computer to resize the input video sequence are configured to utilize seam carving, and
wherein the seam carving is utilized to generate the metadata.

59. The computer-readable storage medium of claim 58, wherein the instructions for causing a computer to extract a region of interest from the input video sequence are configured to utilize the metadata generated during the seam carving to determine the region of interest.

60. A computer-readable storage medium operable for streaming a video sequence, comprising:
instructions for causing a computer to resize an input video sequence utilizing seam carving;
instructions for causing a computer to encode the seam carved input video sequence to generate a first description;
instructions for causing a computer to resize the input video sequence utilizing downsampling;
instructions for causing a computer to encode the downsampled video sequence to generate a second description; and
instructions for causing a computer to transmit the first description and the second description to a receiver.

61. A computer-readable storage medium operable for streaming a video sequence, comprising:
instructions for causing a computer to receive a plurality of descriptions corresponding to the video sequence;
instructions for causing a computer to aggregate the plurality of descriptions to generate an aggregated video sequence;
instructions for causing a computer to decode the aggregated video sequence to generate a decoded video sequence;
instructions for causing a computer to render the decoded video sequence at a first display; and
instructions for causing a computer to transmit information corresponding to the decoded and aggregated descriptions for rendering at a second display.

62. The computer-readable storage medium of claim 61, further comprising:
instructions for causing a computer to resize the decoded video sequence utilizing seam lining.

63. A computer-readable storage medium operable for streaming a video sequence, comprising:
instructions for causing a computer to receive a plurality of descriptions corresponding to the video sequence;
instructions for causing a computer to decode the plurality of descriptions to generate a plurality of decoded video sequences;
instructions for causing a computer to aggregate the plurality of decoded video sequences to generate an aggregated video sequence;
instructions for causing a computer to render the aggregated video sequence at a first display; and
instructions for causing a computer to transmit information corresponding to the aggregated and decoded descriptions for rendering at a second display.

64. The computer-readable storage medium of claim 63, further comprising:
instructions for causing a computer to resize the aggregated video sequence utilizing seam lining.
